(19) United States
(12) Patent Application Publication
(10) Pub. No.: US 2020/0114773 A1
(43) Pub. Date: Apr. 16, 2020

(54) Magnetically Secured Charging Devices

(71) Applicant: Stuart Frazer McColl, Sequim, WA (US)

(72) Inventor: Stuart Frazer McColl, Sequim, WA (US)

(21) Appl. No.: 16/157,087

(22) Filed: Oct. 10, 2018

(51) Int. Cl. B60L 53/16; H01R 11/30

(52) U.S. Cl. CPC B60L 53/16; H01R 11/30

(57) ABSTRACT

An electrical supply connector device is provided. The electrical supply connector device comprises a flexible support member and a supply connector frame connected to a lower end of the flexible support member. The supply connector frame comprises a plurality of magnetic nodes that are connected to an electrical power supply. An electrical receiving connector device is also provided. The electrical receiving connector device comprises a receiving connector frame and magnetic nodes attached to the receiving connector frame.

### CROSS-REFERENCE TO RELATED APPLICATIONS

This application claims priority to and the benefit of provisional patent application titled “AUTOMATIC CONNECTION DEVICE” application No. 62/571,242, filed in the United States Patent Office on Oct. 11, 2017, provisional patent application titled “QUICK ELECTRIC CONNECT/DISCONNECT DEVICE” application No. 62/578,662, filed in the United States Patent Office on Oct. 30, 2017, and provisional patent application titled “AUTOMATIC EV CHARGING CONNECTION III” application No. 62/626,203 filed in the United States Patent Office on Feb. 5, 2018. The specifications of the above referenced patent applications are incorporated herein by reference in their entirety.

### BACKGROUND

For thousands of years, people have relied on traditional fossil fuels such as petroleum, coal and other mineral resources as a source of power. The utilization of fossil fuels has enabled large-scale industrial development. However, increased consumption of fossil fuels in recent years has rapidly depleted fossil fuels. In 2017, the United States imported about 19% of the petroleum it consumed; transportation accounts for nearly three-fourth of the total United States petroleum consumption. Usage of more energy efficient vehicles such as hybrid and plug-in electric vehicles reduces the usage of traditional fossil fuels for transportation since hybrid and plug-in electric vehicles typically use less petroleum fuel compared to vehicles that are powered by conventional internal combustion engines. Plug-in electric vehicles and all electric vehicles are capable of being powered solely by electricity which is produced in the United States from natural gas, domestic coal, nuclear energy, solar energy, and other renewable resources.

A plug-in electric vehicle requires a supply point with a cable and an electrical supply connector at an end of the cable that interfaces with a receiving connector on the plug-in electric vehicle to charge the plug-in electric vehicle. The current state of art involves a plug and plug receptor that requires a human being to first precisely align the plug with a plug receptor, and then apply a force to mate the plug with the plug receptor. For example, the Society of Automotive Engineers (SAE) J1772 plug, a five pin plug requires precise manual alignment of the plug and plug receptor, and a substantial force to insert the plug into the plug receptor. The SAE J1772 uses a charging standard conforming to the SAE Electric Vehicle and Plug in Hybrid Electric Vehicle Conductive Charge Coupler standard, document number J1772, published January 2010 (“SAE J1772 standard”. Further human intervention is necessary for activating a switch that enables transfer of electrical power from the electrical supply point to one or more batteries in the plug-in electric vehicle. Alternatively, the current state of the art provides advanced mechanical and/or electrical devices that automatically align and mate the plug and the plug receptor. However, such automatic alignment systems are expensive, fragile, and complicated. An additional critical component of the standard and state of the art is safety involving handling of high voltage as the cable from the electrical supply point usually lies on a pavement and is exposed to dust, heat and moisture, resulting in wear and tear of the cable. Further, the wear and tear of cable may result in electrical shocks to a user when the user is exposed to a bare cable. Though wireless charging devices are available in the market for charging electronic devices, wireless charging device for large vehicles such as electric cars are rarely reported.

Hence, there is a long felt need for a charging device that does not require substantial human effort or intervention to precisely align and mate an electrical supply connector connected to the electrical supply point with an electrical receiving connector connected to the plug-in electric vehicle. Also, there is a need for a charging device that automatically initiates charging of the plug-in electric vehicle after a successful connection is established between the electrical supply connector and the electrical receiving connector. Furthermore, there is a need for a charging device that is inexpensive, simple, safe, and robust. Moreover, there is a need for a charging device that is less susceptible to heat, dust, moisture, and wear and tear.

### SUMMARY OF THE INVENTION

This summary is provided to introduce a selection of concepts in a simplified form that are further disclosed in the detailed description of the invention. This summary is not intended to determine the scope of the claimed subject matter.

The method and charging devices disclosed herein address the above recited needs for a charging device that does requires minimal human effort and intervention to precisely align and mate an electrical supply connector connected to the electrical supply point with an electrical receiving connector connected to the plug-in electric vehicle. Furthermore, the charging device disclosed herein automatically initiates charging of the plug-in electric vehicle after a successful connection is established between the electrical supply connector and the electrical receiving connector. Furthermore, the charging device disclosed herein is inexpensive, simple, safe, and robust. Moreover, the charging device disclosed herein is less susceptible to heat, dust, moisture, and wear and tear.

The electrical supply connector device disclosed herein comprises a flexible support member and a supply connector frame connected to a lower end of the flexible support member. The supply connector frame comprises magnetic nodes. For example, the magnetic nodes are mounted on the supply connector frame.

The electrical receiving connector device disclosed herein comprises a receiving connector frame and magnetic nodes mounted on the receiving connector frame.

In the method disclosed herein, the electrical supply connector device and the receiving connector device are attached. For example, the electrical supply connector device and the receiving connector device are attached in order to initiate a flow of electrical current from the electrical supply connector device to the receiving connector device. The magnetic nodes on the supply connector frame and the magnetic nodes on the receiving connector frame are arranged in a first configuration. The receiving connector frame is aligned with the supply connector frame. The receiving connector frame is advanced towards the supply connector frame. The magnetic nodes on the supply connector frame are attached to a corresponding one of the magnetic nodes on the receiving connector frame. The flexible support member comprising the supply connector frame located at the lower end of the flexible support member reduces the precision and force required for establishing a connection between the electrical supply connector device and the electrical receiving connector device. The flexible support member provides a flexibility for movement of the supply connector frame towards the receiving connector frame when the magnetic nodes on the supply connector frame and the plurality of magnetic nodes on the receiving connector frame of the electrical receiving connector device are in proximity with each other. The magnetic nodes on the supply connector frame are configured to magnetically attract and attach to the corresponding one of the magnetic nodes on the receiving connector frame.

In one or more embodiments, related systems comprise circuitry and/or programming for effecting the methods disclosed herein. The circuitry and/or programming can be any combination of hardware, software, and/or firmware configured to implement the methods disclosed herein depending upon the design choices of the system designer. Also, in an embodiment, various structural elements can be employed depending on the design choices of the system designer.

### BRIEF DESCRIPTION OF THE DRAWINGS

The foregoing summary, as well as the following detailed description of the invention, is better understood when read in conjunction with the appended drawings. For illustrating the invention, exemplary constructions of the invention are shown in the drawings. However, the invention is not limited to the specific methods and components disclosed herein. The description of a method step or a component referenced by a numeral in a drawing is applicable to the description of that method step or component shown by that same numeral in any subsequent drawing herein.

FIG. 1A illustrates a front elevation view of an electrical supply connector device with a flexible support member comprising a first spring member and a second spring member located along a length of the flexible support member.

FIG. 1B illustrates a bottom view of the electrical supply connector device showing a cancelling of opposing torsional forces of the first spring member and the second spring member mounted side by side.

FIG. 2A illustrates a front side perspective view of the electrical supply connector device with the first spring member and the second spring member in a relaxed state.

FIG. 2B illustrates a front side perspective of the electrical supply connector device with the first spring member and the second spring member stretched to enable a supply connector frame to connect with a receiving connector frame of a receiving connector device to charge an electric vehicle.

FIG. 3A illustrates a perspective view of the supply connector frame and the receiving connector frame.

FIG. 3B illustrates a perspective view of magnetic nodes on the supply connector frame connected to the magnetic nodes on the receiving connector frame to charge an electric vehicle connected to the receiving connector device.

FIG. 4 illustrates a side view of an alternative embodiment of an electrical supply connector device with a swivel structure adapted to align the magnetic nodes positioned on the supply connector frame to the magnetic nodes located on the receiving connector frame.

FIG. 5A illustrates a supply relay circuit for initiating a flow of electrical current from an electrical power supply to the magnetic nodes of the electrical supply connector device.

FIG. 5B illustrates a receiving relay circuit for establishing a circuit path for flow of the electrical current through the magnetic nodes of the electrical receiving connector device.

FIG. 6A and FIG. 6B illustrate perspective views of a license plate frame sized receiving connector frame and a license plate frame sized supply connector frame.

FIG. 7A and FIG. 7B illustrate perspective views of an alternative embodiment of the license plate frame sized receiving connector frame and the license plate frame sized supply connector frame that use inductive power transmission for charging the electric vehicle.

FIG. 8 illustrates an embodiment of an intervention circuit designed to allow an electric vehicle to pull away from a breakable magnet connection between the magnetic nodes of the supply connector frame and the magnetic nodes of the receiving connector frame.

FIG. 9 illustrates a method for attaching an electrical supply connector device and a receiving connector device.

### DETAILED DESCRIPTION OF THE INVENTION

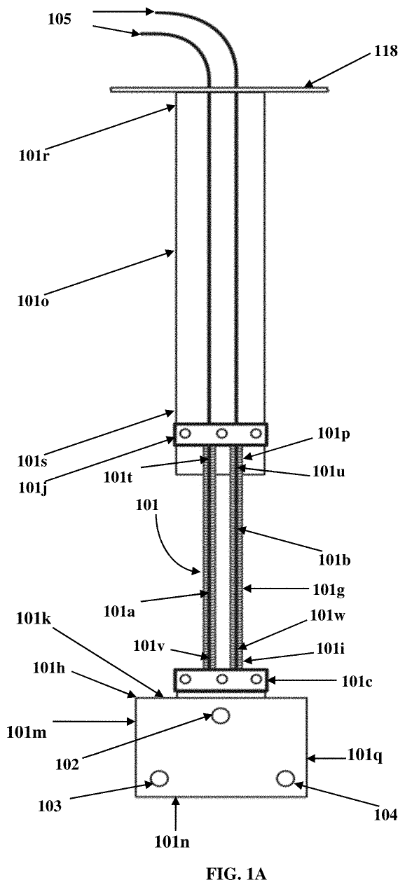

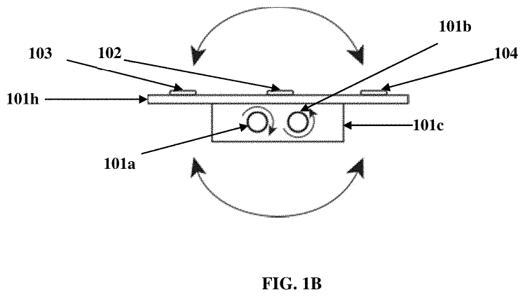

FIG. 1A illustrates a front elevation view of an electrical supply connector device 101 with a flexible support member 101g comprising a first spring member 101a and a second spring member 101b located along a length of the flexible support member 101g. In an embodiment, the flexible support member 101g is a combination of the first spring member 101a and the second spring member 101b.

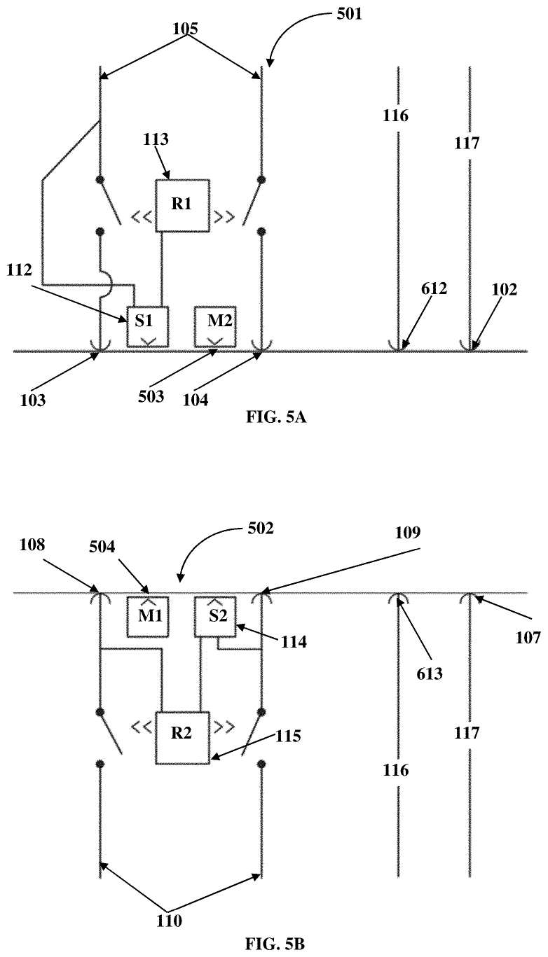

In an embodiment, the electrical supply connector device 101 comprises a flexible support member 101g and a supply connector frame 101h connected to a lower end 101i of the flexible support member 101g. The supply connector frame 101h comprises magnetic nodes 102, 103, and 104. The magnetic nodes 102, 103, and 104 are configured to be connected to an electrical power supply 105. For example, the magnetic nodes 102, 103, and 104 are configured to be connected to the electrical power supply 105 through a supply relay circuit 501, as exemplarily illustrated in FIG. 5A. For example, the magnetic nodes 103 and 104 are connected to live and neutral wires 105, respectively, of the electrical power supply, and the magnetic node 102 is connected to a ground wire 117 of the electrical power supply.

As shown in FIG. 1A, the electrical supply connector device 101 further comprises an elongated support member 101o. The elongated support member 101o comprises a first end 101r and a second end 101s. The second end 101s of the elongated support member 101o is attached to an upper end 101p of the flexible support member 101g. The elongated support member 101o may be attached to a rigid support structure 118, and the first end 101r of said elongated support member 101o is attached to the rigid support structure 118 through one or more fasteners. Examples of rigid support structure 118 comprise a beam, a wall, etc.

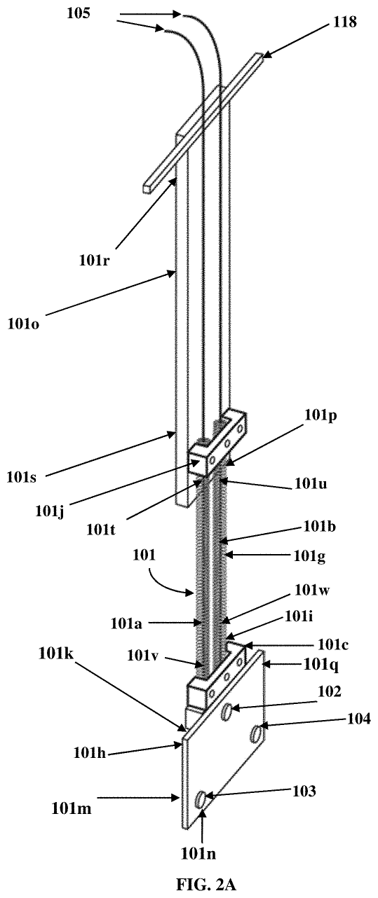

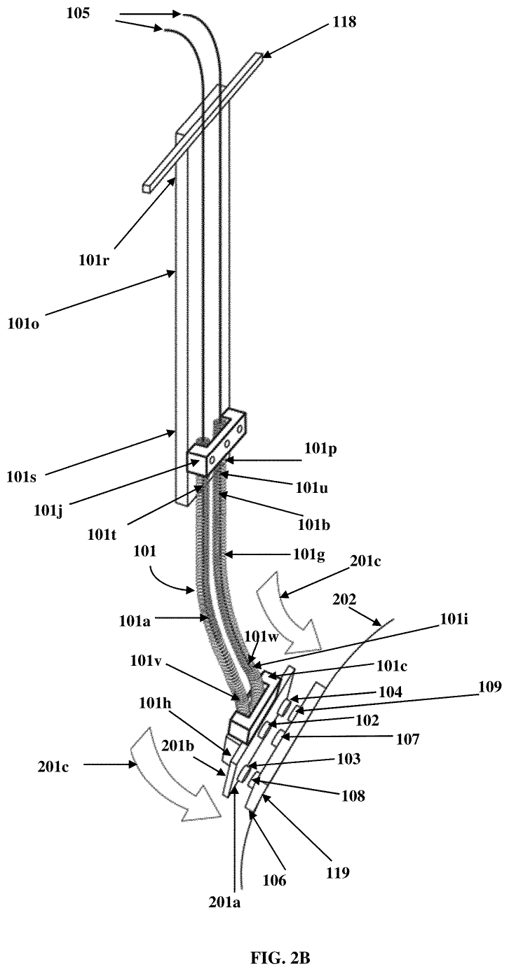

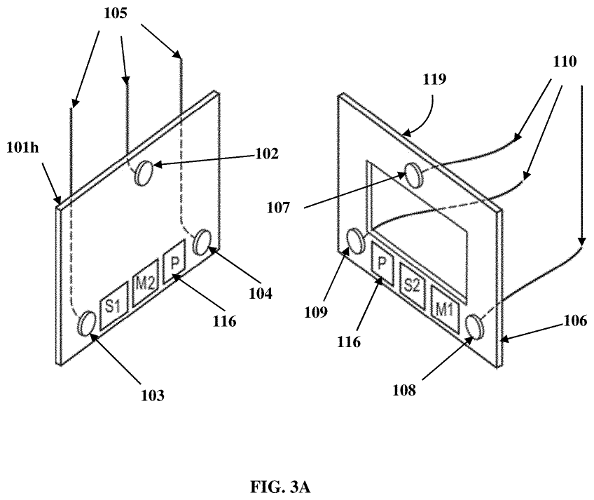

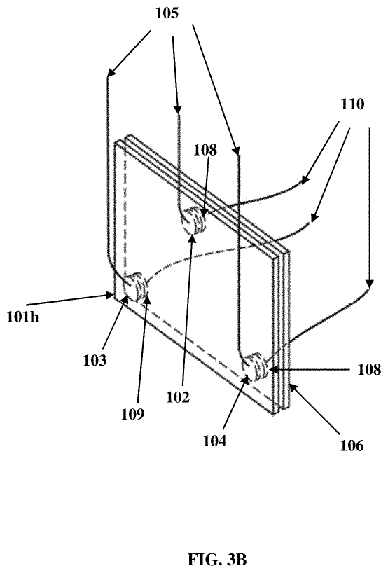

In an embodiment, the electrical supply connector device 101 is used to charge an electric vehicle 202. The electric vehicle 202 to be charged using the electrical supply connector device 101 comprises an electrical receiving connector device 119 as exemplarily illustrated in FIG. 2B. The electrical receiving connector device 119 comprises a receiving connector frame 106 and magnetic nodes 107, 108, and 109 attached to the receiving connector frame 106, as exemplarily illustrated in FIGS. 2B and 3A.

In an embodiment, the flexible support member 101g comprises a first spring member 101a and a second spring member 101b, located along a length of the flexible support member 101g. Furthermore, the first spring member 101a and the second spring member 101b are arranged substantially parallel to each other. The flexible support member 101g comprises a first binder 101j and a second binder 101c. An upper end 101t of the first spring member 101a and an upper end 101u of the second spring member 101b are fastened to the first binder 101j. A lower end 101v of the first spring member 101a and a lower end 101w of the second spring member 101b are fastened to the second binder 101c, as exemplarily illustrated in FIG. 1A. In an embodiment, the supply connector frame 101h is connected to the flexible support member 101g proximal to the second binder 101c. Further, the direction of winding of the first spring member 101a is opposite to the direction of winding of the second spring member 101b. The parallel arrangement of the first spring member 101a and the second spring member 101b, and binding of the first spring member 101a and the second spring member 101b using the first binder 101j and the second binder 101c neutralize and cancel opposing torsional forces of the first spring member 101a and the second spring member 101b, and positions the supply connector frame 101h comprising the magnetic nodes 102, 103, and 104 perpendicular to the first spring member 101a and the second spring member 101b. Neutralizing and canceling the opposing torsional forces cause the supply connector frame 101h comprising the magnetic nodes 102, 103, and 104 to align perpendicular to the first spring member 101a and the second spring member 101b. The perpendicular alignment of the supply connector frame 101h to the first spring member 101a and the second spring member 101b enables the supply connector frame 101h comprising the magnetic nodes 102, 103, and 104 to align with the receiving connector frame 106 comprising magnetic nodes 107, 108, and 109, as exemplarily illustrated in FIG. 2B. The first spring member 101a and the second spring member 101b carry weight of the supply connector frame 101h. The first binder 101j and the second binder 101c hold the first spring member 101a and the second spring member 101b together, and connect the first spring member 101a and the second spring member 101b to the supply frame 101h.

The supply connector frame 101h comprises a first substantially flat surface 201a and a second substantially flat surface 201b below the first substantially flat surface 201a, as exemplarily illustrated in FIG. 2B. The supply connector frame 101h is connected to the lower end 101i of the flexible support member 101g through the second substantially flat surface 201b.

FIG. 1B illustrates a bottom view of the electrical supply connector device 101 showing the neutralization and canceling of opposing torsional forces of the first spring member 101a and the second spring member 101b mounted side by side. As exemplarily illustrated in FIG. 1B, the first spring member 101a and the second spring member 101b are positioned substantially parallel to each other. Further, the direction of winding of the first spring member 101a is opposite to the direction of winding of the second spring member 101b. The substantially parallel arrangement of the first spring member 101a and the second spring member 101b, and binding of the first spring member 101a and the second spring member 101b using the first binder 101j and the second binder 101c, as exemplarily illustrated in FIG. 1A, neutralize and cancel opposing torsional forces of the first spring member 101a and the second spring member 101b.

FIG. 2A illustrates a front left side perspective view of the electrical supply connector device 101 with the first spring member 101a and the second spring member 101b in a relaxed state. Consider an example where the first spring member 101a is wound in a clockwise direction and the second spring member 101b is wound in a counter clockwise direction to neutralize and cancel the opposing torsional forces of the first and second spring members 101a and 101b. By neutralizing and canceling the opposing torsional forces, the supply connector frame 101h comprising the magnetic nodes 102, 103, and 104 is aligned substantially perpendicular to the first spring member 101a and the second spring member 101b. Furthermore, by neutralizing and canceling the opposing torsional forces, the supply connector frame 101h is aligned substantially in the same plane as the first spring member 101a and the second spring member 101b. The alignment of the supply connector frame 101h perpendicular to the first spring member 101a and the second spring member 101b, and the alignment of the supply connector frame 101h substantially in the same plane as the first spring member 101a, the second spring member 101b enables alignment of the supply connector frame 101h comprising the magnetic nodes 102, 103, and 104 with the receiving connector frame 106 comprising the magnetic nodes 107, 108, and 109, as exemplarily illustrated in FIGS. 2A and 2B.

In an embodiment, the electrical supply connector device 101 comprising the flexible support member 101g and the supply connector frame 101h comprising the magnetic nodes 102, 103, and 104 reduces the precision and force required for establishing a connection between the electrical supply connector device 101 and an electrical receiving connector device 119, as shown in FIG. 2B.

FIG. 2B illustrates a front side perspective of the electrical supply connector device 101 with the first spring member 101a and the second spring member 101b stretched to enable a supply connector frame 101h to connect with a receiving connector frame 106 of an electrical receiving connector device 119 to charge an electric vehicle 202. The flexible support member 101g reduces the precision required for establishing the connection between the electrical supply connector device 101 and the electrical receiving connector device 119 by providing flexibility for movement of the supply connector frame 101h towards the receiving connector frame 106 when the magnetic nodes 102, 103, and 104 on the supply connector frame 101h and magnetic nodes 107, 108, and 109 on the receiving connector frame 106 are in proximity with each other.

FIG. 3A illustrates a perspective view of the supply connector frame 101h and the receiving connector frame 106. FIG. 3B illustrates a perspective view of magnetic nodes 102, 103, and 104 in the supply connector frame 101h connected to the magnetic nodes 107, 108, and 109 in the receiving connector frame 106 to charge an electric vehicle 202 connected to the electrical receiving connector device 119. The magnetic nodes 102, 103, and 104 on the supply connector frame 101h are configured to magnetically attract and attach to a corresponding one of the magnetic nodes 107, 108, and 109 on the receiving connector frame 106. For example, the magnetic node 102 on the supply connector frame 101h is configured to magnetically attract and attach to magnetic node 107 on the receiving connector frame 106, as illustrated in FIGS. 2B and 3B. Similarly, for example, the magnetic nodes 103 and 104 on the supply connector frame 101h are configured to magnetically attract and attach to magnetic nodes 108 and 109, respectively on the receiving connector frame 106, as illustrated in FIGS. 2B and 3B.

In the above embodiment, the precision and force required for establishing a connection between the electrical supply connector device 101 and an electrical receiving connector device 119 is significantly less compared to a conventional plugged connection, while simultaneously providing flexibility to the magnetic nodes 102, 103, and 104 in the supply connector frame 101h to magnetically attract and attach to a corresponding one of the magnetic nodes 107, 108, and 109 in the receiving connector frame 106.

In an embodiment, the magnetic nodes 102, 103, and 104 on the supply connector frame 101h and the magnetic nodes 107, 108, and 109 on the receiving connector frame 106 are electrically conductive, and include one or a combination of permanent magnets, electro-permanent magnets and electromagnets. Furthermore, the magnetic nodes 102, 103, and 104 on the supply connector frame 101h are physically mounted on the supply connector frame 101h, and the magnetic nodes 107, 108, and 109 on the receiving connector frame 106 are physically mounted on the receiving connector frame 106. For example, the magnetic nodes 102, 103, and 104, and the magnetic nodes 107, 108, and 109 are physically hard mounted by drilling or welding the magnetic nodes 102, 103, 104, 107, 108, and 109 on the supply connector frame 101h and the receiving connector frame 106. The magnetic nodes 102, 103, 104, 107, 108, and 109 do not require resilient mounts to connect with another one of the magnetic nodes 102, 103, 104, 107, 108, and 109.

In an embodiment, the first spring member 101a and the second spring member 101b that are located along the length of the flexible support member 101g allow the electrical supply connector device 101 to be stretched and pulled towards the receiving connector device 119 for attaching the magnetic nodes 102, 103, and 104 on the supply connector frame 101h to the corresponding one of the magnetic nodes 107, 108, and 109 on the receiving connector frame 106.

As exemplary illustrated in FIG. 1A, the magnetic nodes comprise a first magnetic node 102, a second magnetic node 103, and a third magnetic node 104. The supply connector frame 101h comprises a first side 101k, a second side 101q, a third side 101m, and a fourth side 101n located adjacent to the first substantially flat surface and the second substantially flat surface. The first side 101k is located adjacent to the second side 101q and the third side 101m, and the first magnetic node 102, the second magnetic node, 103 and the third magnetic node 104 are located on the first substantially flat surface proximal to the first side 101k, the second side 101q, and the third side 101m as exemplarily illustrated in FIG. 1A.

In an embodiment, as shown in FIG. 2A, the first side 101k is located adjacent to the second side 101q and the third side 101m, and the fourth side 101n is located opposite to the first side 101k, and adjacent to the second side 101q and the third side 101m. The first magnetic node 102 is located on the first substantially flat surface proximal to the first side 101k, and the second magnetic node 103 and the third magnetic node 104 are located on the first substantially flat surface proximal to the fourth side 101n. Thus, the magnetic nodes 102, 103, and 104 in the supply connector frame 101h are arranged in a first configuration, for example, a tripod configuration. In the tripod configuration, the magnetic node 102 is located proximal to the first side 101k, and the second magnetic node 102 and the third magnetic node 103 are located proximal to the fourth side 101n.

In an embodiment, the electrical receiving connector device 119 comprises a receiving connector frame 106 and magnetic nodes 107, 108, and 109 attached to the receiving connector frame 106, as exemplarily illustrated in FIG. 3A. The magnetic nodes 107, 108, and 109 on the receiving connector frame 106 and the magnetic nodes 102, 103, and 104 on the supply connector frame 101h are arranged in the first configuration, for example, a tripod configuration. The magnetic nodes 102, 103, and 104 located in the supply connector frame 101h are configured to magnetically mate and fasten to the magnetic nodes 107, 108, and 109 located in the receiving connector frame 106.

As exemplarily illustrated in FIG. 2A, the counter wound spring members 101a, 101b located along the length of the flexible support member 101g are in a relaxed, magnetically unattached state with the spring members 101a and 101b in a straight posture. As shown in FIG. 1A, the second binder 101c secures the first and second counter wound springs 101a and 101b to the supply connector frame 101h comprising the magnetic nodes 102, 103, and 104 located along the first side 101k, second side 101q, and third side 101m of the supply connector frame 101h. In an embodiment, the flexible support member 101g has only one spring member 101a secured by the binder 101c to the frame 101h comprising the magnetic nodes 102, 103, and 104.

As exemplarily illustrated in FIG. 2B, the spring members 101a and 101b located along the length of the flexible support member 101g provide the required stretch 201c necessary for the electrical supply connector device 101 to pull itself towards the receiving connector frame 106 due to the magnetic force created by the attraction of magnetic nodes 102, 103, and 104 located on the supply connector frame 101 and the magnetic nodes 107, 108, and 109 located on the receiving connector frame 106, and connect with the receiving connector frame 106. More specifically, when the supply connector frame 101h and the receiving connector frame 106 are in proximity with each other, the spring members 101a and 101b stretch 201c allowing the supply connector frame 101h to move towards the receiving connector frame 106 due to the magnetic force created by the attraction of magnetic nodes 102, 103, and 104 located on the supply connector frame 101 and the magnetic nodes 107, 108, and 109 located on the receiving connector frame 106, and connect with the receiving connector frame 106, thereby establishing a magnetic and electrical connection. The electricity necessary for charging the electric vehicle 202 through the wires 105 is supplied once the magnetic nodes 102, 103, and 104 located on the supply connector frame 101h attach to the magnetic nodes 107, 108, and 109 on the receiving connector frame 106.

The electrical supply connector device 101 disclosed herein allows an otherwise non-precisely aligned supply connector frame 101h to align and connect with a receiving connector frame 106. The spring members 101a and 101b of the flexible support member 101g offer the required stretch 201c necessary for the supply connector frame 101h to pull itself towards the receiving connector frame 106 that may be out of alignment or distanced from the supply connector frame 101h, for example, by about 3 inches or less, with a magnetic force created due to attraction of magnetic nodes 102, 103, and 104, with magnetic nodes 107, 108, and 109, and connect with the receiving connector frame 106. The electrical supply connector device 101 comprises affordable components comprising first and second spring members 101a and 101b, and magnetic connectors 102, 103, and 104. The electrical supply connector device 101 allows establishment of a reliable magnetic connection for charging an electric vehicle 202. Furthermore, the electrical supply connector device 101 is simply retracted away when the charging is complete to terminate the connection.

As exemplarily illustrated in FIG. 3A, the magnetic nodes 102, 103, and 104 in the supply connector frame 101h are configured to magnetically attach to corresponding magnetic nodes 107, 108, and 109 in the receiving connector frame 106 of an electrical receiving connector device 119 when the supply connector frame 101h and the receiving connector frame 106 are in proximity with each other, and when the magnetic nodes 102, 103, 104, 107, 108, and 109 in the supply connector frame 101h and the receiving connector frame 106 are arranged in the first configuration, for example, the tripod configuration. The magnetic nodes 102, 103, and 104 located in the supply connector frame 101h are configured to magnetically mate and fasten to the magnetic nodes 107, 108, and 109 located in the receiving connector frame 106.

As illustrated in FIG. 3A, the magnetic nodes 102, 103, and 104 located in the supply connector frame 101h connect to magnetic nodes 107, 108, and 109 located on a receiving connector frame 106 to charge the electric vehicle 202. The magnetic nodes 102, 103, and 104 are electrically conductive. The magnetic nodes 102, 103, and 104 located on the supply connector frame 101h and the magnetic nodes 107, 108, and 109 located on the receiving connector frame 106 are electrically wired 105 and 110 to carry high voltage for charging an electric vehicle 202. In an embodiment, the magnetic nodes 103 and 104 are connected to live and neutral wires 105, respectively, of the electrical power supply, and the magnetic node 102 is connected to a ground wire 117 of the electrical power supply. Similarly, the magnetic nodes 108 and 109 are connected to a battery of an electric vehicle 202, and the magnetic node 107 is connected to a ground point of the electric vehicle 202. Thus, the exposed magnetic nodes 102, 103, 104, 107, 108, and 109 are magnets that are electrically conductive and wired 105 and 110 to transfer or receive electricity. Magnetic nodes 102, 103, 104, 107, 108, and 109 provide the force to secure and hold the connectors together and also conduct the electrical current from the electrical supply connector device 101 to the electrical receiving connector device 119.

The magnetic nodes 102, 103, and 104 located in the supply connector frame 101h and the magnetic nodes 107, 108, and 109 located in the receiving connector frame 106 are tripod magnetic node mirrors, to magnetically mate the supply connector frame 101h to the receiving connector frame 106 located on the electric vehicle 202, to charge the electric vehicle 202. As both the connector assemblies employ a tripod scheme for the arrangement of magnetic nodes 102, 103, 104, 107, 108, and 109, resilient mechanisms are not necessary since the tripod scheme provides hard physical mating of each of the magnetic nodes 102, 103, 104, 107, 108, and 109 on both the electrical supply connector device 101 and the electrical receiving connector device 119.

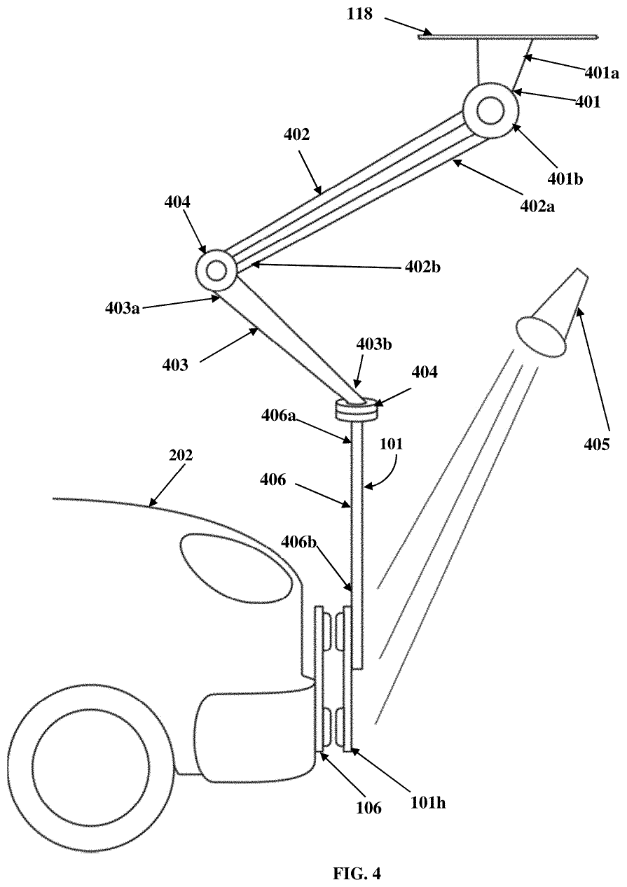

FIG. 4 exemplary illustrates a side view of an alternative embodiment of an electrical supply connector device 101 with a swivel structure 401 to align the magnetic nodes 102, 103, and 104 positioned on the supply connector frame 101h with the magnetic nodes 107, 108, and 109 located on the receiving connector frame 106. In this embodiment, the electrical supply connector device 101 comprises a swivel structure 401, a first arm 402, a second arm 403, and a movable joint 404. The movable joint 404 connects an upper end 406a of a flexible support member 406 with a second end 403b of the second arm 403. The swivel structure 401 comprises a base 401a and a rotatable member 401b.

In an embodiment, the rotatable member 401b, for example, is configured to rotate the first arm 402, the second arm 403, the movable joint 404, and the electrical supply connector device 101 about a horizontal axis of the base 401a. In another embodiment, the rotatable member 401b, for example, is configured to rotate the first arm 402, the second arm 403, the movable joint 404, and the electrical supply connector device 101 about one or more of a horizontal axis and a vertical axis of the base 401a. The first arm 402 comprises a first end 402a connected to the rotatable member 401b and a second end 402b connected to a first end 403a of the second arm 403. The second end 403b of the second arm 403 is connected to a first end 406a of the flexible support member 406 and a second end 406b of the flexible support member 406 is attached to the supply connector frame 101h. In this embodiment, movements of the flexible support member 406 connecting the supply connector frame 101h is activated by a sensor 405 using servo motors located in the movable joint 404 and the swivel structure 401.

The movable joint 404 is configured to rotate the electrical supply connector device 101 about a vertical axis of the supply connector device 101. The sensor 405 monitors and identifies a location of the receiving connector frame 106. After identifying the location of the receiving connector frame 106, the sensor 405 utilizes a control circuitry to provide signals to the servo motors in the swivel structure 401 and the moveable joint 404, to position the supply connector frame 101h into connectable proximity of the receiving connector frame 106. Therefore, the sensor 405 enables the supply connector frame 101h to attach to the receiving connector frame 106, when the electric vehicle 202 equipped with receiving connector frame 106 approaches the supply connector frame 101h. In this embodiment, the structure of the flexible support member 406 may be similar to the structure of the flexible support member 101g described in FIGS. 1A, 1B, 2A and 2B. Alternatively, flexible support member 406 comprises hinged mechanisms for connecting to the supply connector frame and the second arm 403.

FIG. 5A illustrates a supply relay circuit 501 for initiating a flow of electrical current from the electrical power supply 105 to the magnetic nodes 103 and 104 of the electrical supply connector device 101. In an embodiment, the supply relay circuit 501 is located within the electrical supply connector device 101. FIG. 5B illustrates a receiving relay circuit 502 for establishing a circuit path for flow of the electrical current through the magnetic nodes 108 and 109 of the electrical receiving connector device 119. In an embodiment, the receiving relay circuit 502 is located within the electrical receiving connector device 119.

In an embodiment, the supply relay circuit 501 comprises a first reed switch S1 112 and a second magnet M2 503. The first reed switch S1 112 is activated due to proximity of a first magnet M1 504 in the receiving relay circuit 502 of the receiving connector device 119. The activation of the first reed switch S1 112 causes a first relay R1 113 of the supply relay circuit 501 to establish a circuit path for flow of the electrical current from the electrical power supply 105 to the magnetic nodes 103 and 104 on the supply connector frame 101h. The receiving relay circuit comprises a second reed switch S2 114 that is activated by proximity of the second magnet M2 503 in the supply relay circuit 501. The activation of the second reed switch S2 114 causes the second relay R2 115 of the receiving relay circuit 502 to establish a circuit path for flow of the electrical current from the magnetic nodes 103 and 104 on the supply connector frame 101h to one or more batteries connected to the receiving relay circuit 502 through the magnetic nodes 108 and 109 on the receiving connector device 119 attached to the magnetic nodes 103 and 104 of the electrical supply connector device 101.

In an embodiment, the magnetic nodes 103 and 104 on the supply connector frame 101h and the magnetic nodes 108 and 109 on the receiving connector frame 106 are high current exposed magnetic nodes. As exemplarily illustrated in FIGS. 5A and 5B, the high current exposed magnetic nodes, 103, 104, 108, and 109 are only activated when the first magnet M1 504 and the second magnet 503 are proximal to the first reed switch S1 112 and the second reed switch S2 114, respectively. Therefore, the second reed switch S2 114 in not activated in the absence of a proximity of the second magnet M2 503 of the supply connector device 101. Therefore, voltage cannot escape the electric vehicle 202 or batteries of the electric vehicle 202 through relay R2 115 to the exposed high voltage magnetic nodes 108 and 109. Therefore, open relay R2 115 passively protects humans in the vicinity of the electric vehicle 202 during and after charging.

FIG. 5A and FIG. 5B exemplarily illustrates wires 116, 117 and magnetic nodes 102, 103, 104, 107, 108, and 109, including pilot signal wires 116 and ground wires 117 drawn in to show conformity in this case with SAE J1772 standard. Further, the low current exposed magnetic nodes say, for example 612, 613 and the ground exposed magnetic nodes labeled say, for example, 102, 107 do not pose a threat of electrocution as that of the high voltage exposed magnetic nodes 104, 109, 103 and 108 of the connectors 101h, 106.

Low voltage is not generally dangerous to an user. For instance, a 12 volt car battery has enough wattage to start a car's engine, but because of the low voltage potential in 12 volts, an user cannot be shocked even if he puts his wet hands on both the positive and negative poles of a 12 volt car battery at the same time. Similarly, a common 9 volt radio battery when dragged with wet hands results only an annoying amount of wattage with no injury. High voltage is significantly more dangerous and can potentially kill an user. A typical socket in a house can deliver a severe and possibly life threatening shock at 120 volts. There is therefore usually a significant difference in danger in higher voltages compared to safer lower voltages.

The SAE J1772 standard employs a signaling protocol used for signaling between electric vehicle 202 and the supply connector device 101 to communicate charging states, and to initiate and terminate charging. When the batteries of the electric vehicle 202 are completely charged, the SAE J1772 sends a signal to the supply connector device 101.

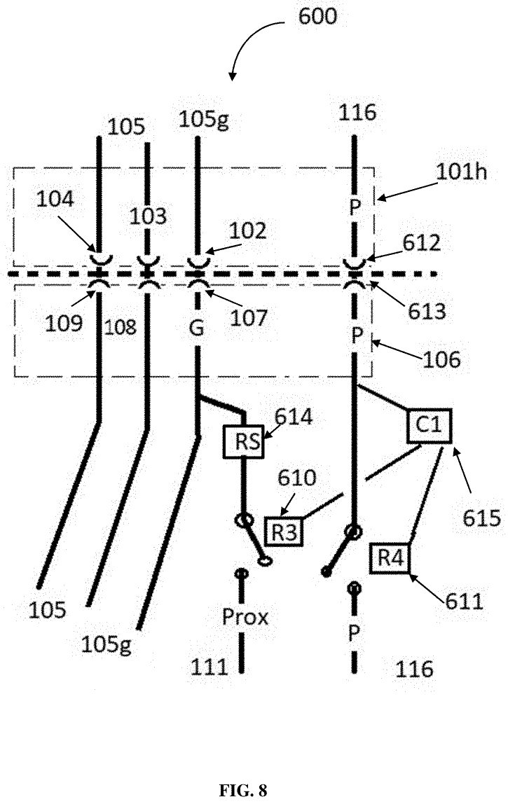

FIG. 8 illustrates an embodiment of an intervention circuit 600 designed to allow an electric vehicle 202 to pull away from a breakable magnet connection between the magnetic nodes 102, 103, and 104 of the supply connector frame 101h and the magnetic nodes 107, 108, and 109 of the receiving connector frame 106. The intervention circuit 600 may for example, be a J1772 intervention circuit 600 designed to allow an electric vehicle 202 to pull away from the breakable magnet connection even when the electric vehicle 202 believes it is “plugged in” to a non-breakable connection. The circuit monitors the J1772 pilot wire ‘P’ 116, for example also illustrated in FIGS. 3A, 5A, and 5B and affects logical electronic charger connection and disconnection to the electric vehicle 202 by opening and closing a third relay R3 610 and a fourth relay R4 611 connecting the proximity wire 111 and pilot wire ‘P’ 116, respectively, with the electric vehicle 202. In an embodiment, the electrical receiving connector device 119 comprises a programmable logic controller (PLC) ‘C1’ 615 wired to the J1772 pilot wire ‘P’ 116. The programmable logic controller (PLC) ‘C1’ 615 is configured to monitor the state of charging of the electric vehicle 202. The programmable logic controller (PLC) ‘C1’ 615 is further configured to completely disconnect the connection of the proximity wire 111 and pilot wire ‘P’ 116 to the electric vehicle 202, upon completion of charging of the electric vehicle, allowing the electric vehicle 202 to drive away even though the magnetic nodes 102, 103, and 104 of the supply connector frame 101h and the magnetic nodes 107, 108, and 109 of the receiving connector frame 106 are still connected through the breakable magnetic connection. In addition, the intervention circuit, upon receiving a signal from the Pilot wire ‘P’ 116, causes the electrical supply connector device 101 to retract away from the electric vehicle 202.

The intervention circuit 600 is further configured to automatically reset itself restoring the third relay R3 610 and the fourth relay R4 611 to the closed position allowing the Pilot wire ‘P’ 116 that is in connection with the charger to open a new communication with the electric vehicle 202 for instigating a logical connection and for providing an opportunity to continue charging or create a new charging process. The closed connection of the proximity wire 111 of the electric vehicle 202 connects the proximity wire 111 to a ground wire 105g and adds an appropriate J1772 signal ohmic resistance RS 614.

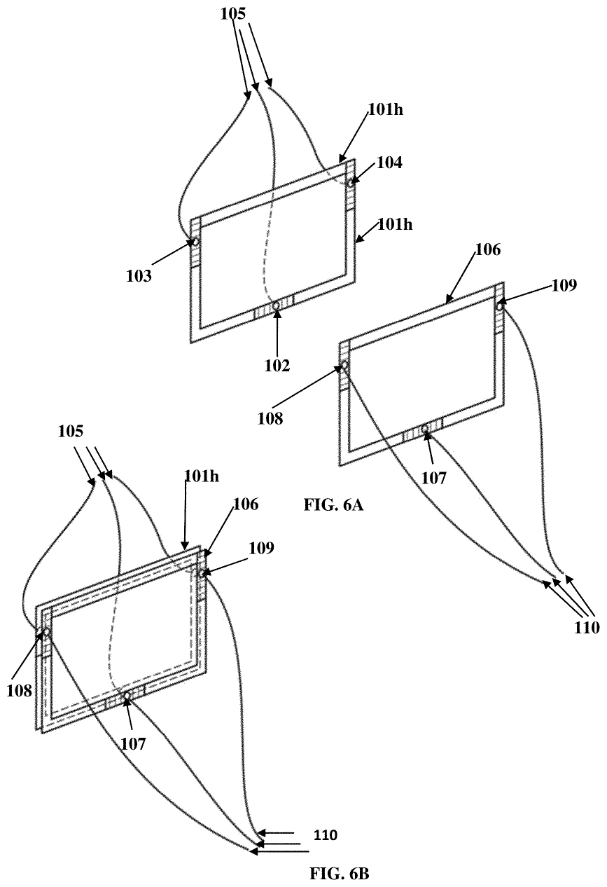

FIGS. 6A and 6B illustrate perspective views of a license plate frame sized receiving connector frame 106 and a license plate frame sized supply connector frame 101h.

In an embodiment, the license plate frame sized receiving connector frame 106 is mounted on a license plate frame of the electric vehicle 202. The license plate frame sized supply connector frame 101h with wires 105 connected to magnetic nodes 102, 103, and 104 on the supply connector frame 101h conducts electricity through the contacts, i.e. magnetic nodes 102, 103, and 104 located on the supply connector frame 101h to contacts, i.e., magnetic nodes 107, 108, and 109 mounted on the receiving connector frame 106. Shape of a license plate and area of installation of the license plate area are in general universally common to each vehicle type, for example, vehicle types such as cars, trucks, motorcycles, etc. Therefore, the receiving connector frame 106 and/or electrical receiving connector device 119 may be designed or manufactured to a specific vehicle type.

As exemplarily illustrated in FIG. 6A, the magnetic nodes 102, 103, and 104 located on the frame of the license plate sized supply connector frame 101h connects to magnetic nodes 107, 108, and 109 located on a license plate sized receiving connector frame 106 in an electric vehicle 202 to charge the electric vehicle 202. The license plate sized receiving connector frame 106 is located on a license mount frame assembly of an electric vehicle 202. The purpose is to use the existing license plate frame assembly of the electric vehicle 202 to connect to the electric vehicle 202 such as a car in a non-intrusive fashion while still providing a large stable area for the supply connector frame 101h to mate to the electric vehicle 202 for delivering an electrical charge to the electric vehicle 202.

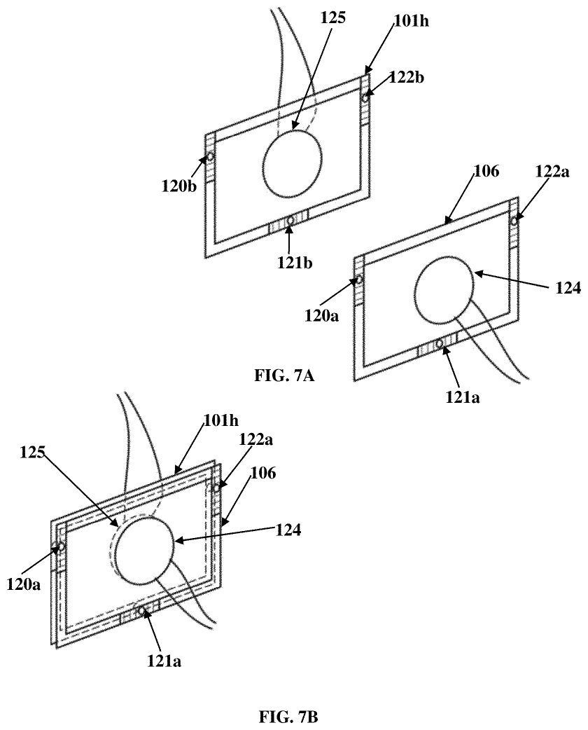

FIGS. 7A and 7B illustrate perspective views of an alternative embodiment of the license plate frame sized receiving connector frame 106 and the license plate frame sized supply connector frame 101h that uses inductive power transmission for charging electric vehicle 202.

As exemplarily illustrated in FIG. 7A, the receiving connector frame 106 comprises permanent and/or electromagnets 120a, 121a, and 122a, and a receiving inductor coil 124. As shown in FIG. 7A, the supply connector frame 101h comprises permanent and/or electromagnets 120b, 121b, and 122b, and a supply inductor coil 125. After the supply connector frame 101h and the receiving connector frame 106 are mated together by the movement of the spring members 101a, 101b, the supply inductor coil 125 is aligned to the receiving inductor coil 124 for charging the electric vehicle 202. The supply inductor coil 125 is configured to generate an electromagnetic field for transferring energy to the receiving inductor coil 124, when the supply inductor coil 125 is aligned with the receiving inductor coil 124.

As exemplarily illustrated in FIGS. 7A and 7B, the permanent and/or electromagnets 120a, 121a, and 122a located on the frame of the license plate sized supply connector frame 101h connect to permanent and/or electromagnets 120b, 121b, and 122b located on a license plate sized receiving connector frame 106 in an electric vehicle 202. Once connected, the supply inductor coil 125 is aligned to the receiving inductor coil 124 thereby allowing current to flow from the supply wires 105 of the license plate sized supply connector frame 101h to the receiving wires 110 of the license plate sized receiving connector frame 106, thereby allowing wireless power transfer.

In an embodiment, the receiving connector frame 106 is part of a side, quarter panel or fender of any electric vehicle 202. The permanent and/or electromagnets 120a, 121a, and 122a and the receiving inductor coil 124 are placed under a body panel of the electric vehicle 202 instead of a license plate frame. Here, when the permanent and/or electromagnets 120b, 121b, and 122b of the supply connector frame 101h are connected to the permanent and/or electromagnets 120a, 121a, and 122a of the receiving connector frame 106, the supply inductor coil 125 uses an electromagnetic field to transfer energy to the receiving inductor coil 124 through the body panel of electric vehicle 202. In an embodiment, the permanent and/or electromagnets 120a, 121a, and 122a of the receiving connector frame 106 are positioned on the body panel of the electric vehicle 202 for the most direct possible inductive connection.

In an embodiment, the supply connector frame 101h is positioned in a predetermined position corresponding to x, y, z coordinates of a license plate of the electric vehicle 202 in a parking garage so that the when electric vehicle 202 with the license plate frame sized receiving connector frame 106 approaches the supply connector frame 101h of the electrical supply connector device 101, the magnetic nodes 107, 108 and 109 of the receiving connector frame 106 is attracted to the magnetic nodes 102, 103, and 104 of the supply connector frame 101h to charge the electric vehicle 202. Here, one end of the elongated support member is attached towards a rigid support structure 118 such as a beam in a parking garage so as to mount the elongated support member to a plug receptor located on the beam to provide power supply to the wires 105 connected to the electrical supply connector device 101.

Thus, the electrical supply connector device 101 uses spring members 101a, 101b, wired magnetic nodes 102, 103, and 104 to provide a cost effective charging device to charge the electric vehicle 202. The magnetic nodes 102, 103, and 104 located in the supply connector frame 101h and the magnetic nodes 107, 108, and 109 located in the receiving connector frame 106 are tripod magnetic node mirrors, to magnetically mate the supply connector frame 101h to the receiving connector frame 106 located on the electric vehicle 202, to charge the electric vehicle 202. Further, the electrical supply and receiving connector devices 101, 119 are only activated when the magnetic nodes 102, 103, 104, 107, 108, and 109 of the electrical supply and receiving connector devices 101, 119 are in proximity.

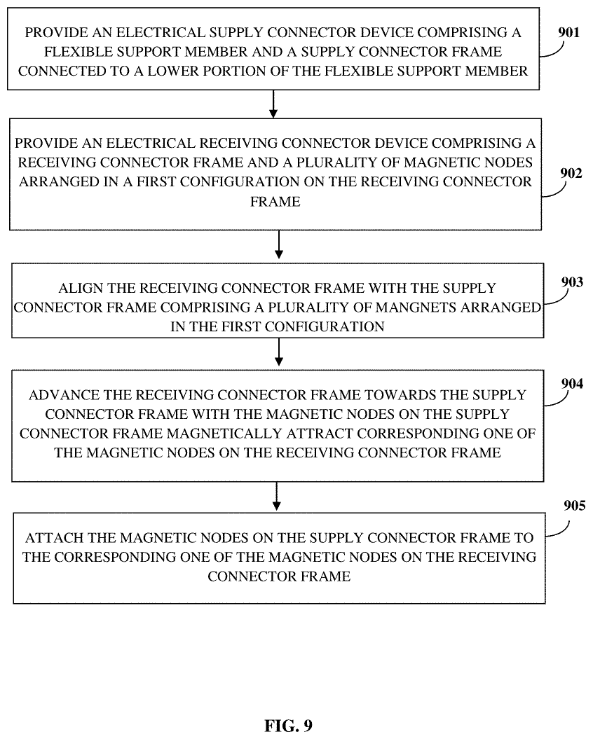

FIG. 9 illustrates a method for attaching an electrical supply connector device 101 and an electrical receiving connector device 119. The method comprises providing 901 an electrical supply connector device 101 comprising a flexible support member 101g and a supply connector frame 101h connected to a lower end 101i of the flexible support member 101g. The supply connector frame 101h comprises a plurality of magnetic nodes 102, 103, and 104 arranged in a first configuration, for example, a tripod configuration, and the magnetic nodes 102, 103, and 104 are connected to an electrical power supply 105 as disclosed in the detailed description of FIGS. 1A and 1B.

The method also provides 902 an electrical receiving connector device 119 comprising a plurality of magnetic nodes 107, 108, and 109 arranged in the first configuration, for example, a tripod configuration as disclosed in the detailed description of FIGS. 3A and 3B. A receiving connector frame 106 of the electrical receiving connector device 119 mounted on an electric vehicle 202 is aligned 903 with the supply connector frame 101h. The receiving connector frame 106 is advanced 904 towards the electrical supply connector device 101. For example, an electric vehicle 202 with the license plate frame sized receiving connector frame 106 approaches the supply connector frame 101h positioned in a predetermined position corresponding to x, y, z coordinates of a license plate of the electric vehicle 202. Next, the magnetic nodes 102, 103, and 104 on the supply connector frame 101h attach 905 to a corresponding one of the magnetic nodes 107, 108, and 109 on the receiving connector frame 106.

A flow of electrical current is initiated from the electrical power supply 105 to the magnetic nodes 102, 103, 104 of the electrical supply connector device 101, when the magnetic nodes 107, 108, 109 of the electrical receiving connector device 119 are in direct contact with the magnetic nodes 102, 103, 104 of the electrical supply connector device 101 by a supply relay circuit as disclosed in the detailed description of FIGS. 5A-5B. A reed switch S1 112 located on the supply relay circuit is activated by the proximity of first magnet M1 504 of the electrical supply connector device 101. Upon activation of the reed switch S1 112, electric current flows through a relay R1 113 thereby allowing electricity to flow from wires 105 connected to the high voltage magnetic nodes say, for example, 108 and 109 exposed on the receiving connector frame 106 through the high voltage magnetic nodes 103 and 104 exposed on the supply connector frame 101h, as disclosed in the detailed description of FIGS. 5A-5B.

In an embodiment, when the receiving connector frame 106 is aligned with a supply connector frame 101h, a circuit path is established for the flow of the electrical current through a receiving relay circuit of the receiving connector device 119 to charge one or more batteries connected to the receiving relay circuit. A reed switch S2 114 located on the receiving connector device 119 is activated by the proximity of a second magnet M2 503 of the electrical supply connector device 101 as disclosed in the detailed description of FIGS. 5A-5B. The activation of a reed switch S2 114 activates an open relay R2 115 thereby enabling flow of electricity from the supply voltage wires 105 to the receiving voltage wires 110 connected to the batteries of electric vehicle 202 through the high voltage magnetic nodes 108 and 109, as disclosed in the detailed description of FIGS. 5A-5B.

In an alternative embodiment, the receiving connector frame 106 comprises permanent and/or electromagnets 120a, 121a, and 122a, and a receiving inductor coil 124. The supply connector frame 101h comprises permanent and/or electromagnets 120b, 121b, and 122b, and a supply inductor coil 125. After the supply connector frame 101h and the receiving connector frame 106 are mated together by the movement of the spring members 101a, 101b, the supply inductor coil 125 is aligned to the receiving inductor coil 124 for charging the electric vehicle 202. The supply inductor coil 125 is configured to generate an electromagnetic field for transferring energy to the receiving inductor coil 124, when the supply inductor coil 125 is aligned with the receiving inductor coil 124.

As exemplarily illustrated in FIG. 7B, the electromagnets 120a, 121a, and 122a located on the frame of the license plate sized supply connector frame 101h connect to electromagnets 120b, 121b, and 122b located on a license plate sized receiving connector frame 106 in an electric vehicle 202. Once connected, the supply inductor coil 125 is aligned to the receiving inductor coil 124 thereby allowing current to flow from the supply wires 105 of the license plate sized supply connector frame 101h to the receiving wires 110 of the license plate sized receiving connector frame 106, thereby allowing wireless power transfer.

The foregoing examples have been provided merely for explanation and are in no way to be construed as limiting of the electrical supply connector device 101 and the electrical receiving connector device 119 disclosed herein. While the electrical supply connector device 101 and the electrical receiving connector device 119 have been described with reference to various embodiments, it is understood that the words, which have been used herein, are words of description and illustration, rather than words of limitation. Furthermore, although the electrical supply connector device 101 and the electrical receiving connector device 119 have been described herein with reference to particular means, materials, and embodiments, the electrical supply connector device 101 and the electrical receiving connector device 119 are not intended to be limited to the particulars disclosed herein; rather, the electrical supply connector device 101 and the electrical receiving connector device 119 extend to all functionally equivalent structures, methods and uses, such as are within the scope of the appended claims. While multiple embodiments are disclosed, it will be understood by those skilled in the art, having the benefit of the teachings of this specification, that the method, the electrical supply connector device 101, and the electrical receiving connector device 119 disclosed herein are capable of modifications and other embodiments may be effected and changes may be made thereto, without departing from the scope and spirit of the electrical supply connector device 101 and electrical receiving connector device 119 disclosed herein.

I claim:

1. An electrical supply connector device, comprising:
a flexible support member; and
a supply connector frame connected to a lower end of said flexible support member, wherein said supply connector frame comprises a plurality of magnetic nodes.

2. The electrical supply connector device of claim 1, wherein said magnetic nodes are electrically conductive, wherein said magnetic nodes comprise one or combination of permanent magnets, electro-permanent magnets and electromagnets, and wherein said magnetic nodes are configured to be connected to an electrical power supply.

3. The electrical supply connector device of claim 1, wherein said supply connector frame comprises a first substantially flat surface and a second substantially flat surface below said first substantially flat surface, wherein said supply connector frame is connected to said lower end of said flexible support member through said second substantially flat surface.

4. The electrical supply connector device of claim 3, wherein said magnetic nodes are arranged on a perimeter of said supply connector frame, and wherein said magnetic nodes comprise a first magnetic node, a second magnetic node, and a third magnetic node.

5. The electrical supply connector device of claim 3, wherein said supply connector frame comprises a first side, a second side, a third side, and a fourth side located adjacent to said first substantially flat surface and said second substantially flat surface.

6. The electrical supply connector device of claim 5, wherein said first side is located adjacent to said second side and said third side, and wherein said first magnetic node, said second magnetic node, and said third magnetic node are located on said first substantially flat surface proximal to said first side, said second side, and said third side.

7. The electrical supply connector device of claim 5, wherein said first side is located adjacent to said second side and said third side, wherein said fourth side is located opposite to said first side, and adjacent to said second side and said third side, wherein said first magnetic node is located on said first substantially flat surface proximal to said first side, and wherein said second magnetic node and said third magnetic node are located on said first substantially flat surface proximal to said fourth side.

8. The electrical supply connector device of claim 1, further comprising an elongated support member comprising a first end and a second end, wherein said second end is attached to an upper end of said flexible support member, and wherein said first end of said elongated support member is configured to attach said elongated support member to a rigid support structure.

9. The electrical supply connector device of claim 8, wherein said flexible support member comprises a first spring member and a second spring member, located along a length of said flexible support member, wherein said flexible support member further comprises a first binder and a second binder, wherein said first binder is configured to fasten an upper end of said first spring member to an upper end of said second spring member, and wherein said second binder is configured to fasten a lower end of said first spring member to a lower end of said second spring member, and wherein said supply connector frame is connected to said flexible support member proximal to said second binder.

10. The electrical supply connector device of claim 9, wherein a direction of winding of said first spring member is opposite to said direction of winding of said second spring member to cancel opposing torsional forces of said first spring member and said second spring member and position said supply connector frame comprising said magnetic nodes perpendicular to said first spring member and said second spring member.

11. The electrical supply connector device of claim 10, wherein said flexible support member, comprising said supply connector frame connected to said lower end of said flexible support member, reduces a precision and a force required for establishing a connection between said electrical supply connector device and an electrical receiving connector device by providing flexibility for movement of said supply connector frame towards a receiving connector frame when said magnetic nodes on said supply connector frame and a plurality of magnetic nodes on said receiving connector frame of said electrical receiving connector device are in proximity with each other, wherein said magnetic nodes on said supply connector frame arranged in a first configuration are configured to magnetically attract and attach to a corresponding one of said magnetic nodes on said receiving connector frame, and wherein said plurality of magnetic nodes on said receiving connector frame are arranged in said first configuration.

12. The electrical supply connector device of claim 11, wherein said first spring member and said second spring member located along said length of said flexible support member provide said electrical supply connector device with a stretch required to pull said electrical supply connector device towards said electrical receiving connector device with a magnetic force for attaching said magnetic nodes on said supply connector frame to said corresponding one of said magnetic nodes on said receiving connector frame.

13. The electrical supply connector device of claim 11, wherein said first configuration of arrangement of said magnetic nodes located on said supply connector frame and said magnetic nodes located on said receiving connector frame is a tripod configuration, wherein said magnetic nodes located on said supply connector frame are configured to magnetically mate and fasten to said magnetic nodes located on said electrical receiving connector device, wherein said magnetic nodes on said supply connector frame are physically mounted on said supply connector frame, and wherein said magnetic nodes on said receiving connector frame are physically mounted on said receiving connector frame.

14. The electrical supply connector device of claim 13 further comprising a supply relay circuit, wherein said supply relay circuit comprises a first reed switch that is activated by a proximity of a first magnet mounted on said electrical receiving connector device, wherein a first relay of said supply relay circuit, on said activation of said first reed switch, is configured to establish a circuit path for flow of said electrical current from said electrical power supply to said magnetic nodes exposed on said supply connector frame.

15. The electrical supply connector device of claim 14, wherein said electrical receiving connector device comprises a receiving relay circuit comprising a second reed switch that is activated by a proximity of a second magnet mounted on said electrical supply connector device, wherein said second relay of said receiving relay circuit, on said activation of said second reed switch, is configured to establish a circuit path for flow of said electrical current from said magnetic nodes on said supply connector frame to one or more batteries connected to said receiving relay circuit, through said magnetic nodes of said electrical receiving connector device attached to said magnetic nodes of said electrical supply connector device.

16. The electrical supply connector device of claim 1, further comprising a swivel structure, a first arm, a second arm, and a movable joint connecting an upper end of said flexible support member with a second end of said second arm, wherein said swivel structure comprises a base and a rotatable member configured to rotate about an axis of said base, and wherein said first arm comprises a first end connected to said rotatable member and a second end connected to a first end of said second arm.

17. The electrical supply connector device of claim 1, wherein said supply connector frame comprises a supply inductor coil configured to generate an electromagnetic field for transferring energy to a receiving inductor coil of a receiving connector frame, when said supply inductor coil is aligned with said receiving inductor coil.

18. An electrical receiving connector device, comprising:
a receiving connector frame; and
a plurality of magnetic nodes mounted on said receiving connector frame.

19. The electrical receiving connector device of claim 18, wherein said magnetic nodes are electrically conductive, and wherein said magnetic nodes comprise one of permanent magnets, electro-permanent magnets and electromagnets.

20. The electrical receiving connector device of claim 18, further comprising a receiving relay circuit connected to said magnetic nodes of said electrical receiving connector device, wherein said receiving relay circuit comprises a second reed switch that is activated by a proximity of a second magnet mounted on said electrical supply connector device, wherein said second relay of said receiving relay circuit, on said activation of said second reed switch, is configured to establish a circuit path for flow of electrical current from said magnetic nodes to one or more batteries connected to said receiving relay circuit.

21. The electrical receiving connector device of claim 18, wherein said receiving connector frame comprises a receiving inductor coil configured to charge one or more batteries using a flow of electrical current induced by an electromagnetic field, wherein said electromagnetic field is generated by a supply inductor coil of a supply connector frame, when said supply inductor coil is aligned with said receiving inductor coil.

22. The electrical receiving connector device of claim 18, wherein said receiving connector frame is in a shape of a standard license plate of an automobile, and wherein said receiving connector frame is configured to be installed in place of said standard license plate.

23. An intervention circuit for allowing an electric vehicle to pull away from an electrical connection between an electrical receiving connector device of said electric vehicle and an electrical supply connector device, said intervention circuit comprising:
a programmable logic controller configured to open and close a third relay and a fourth relay;
said third relay for establishing a proximity wire connection between said electric vehicle and said electrical supply connector device;
said fourth relay for establishing a pilot wire connection between said electric vehicle and said electrical supply connector device; and
said programmable logic controller connected to said pilot wire connection from said electrical supply connector device, wherein said programmable logic controller is configured to monitor a state of charging of said electric vehicle, wherein said programmable logic controller is further configured to disconnect said proximity wire connection by opening said third relay and disconnect said pilot wire connection by opening said fourth relay, upon completion of charging of said electric vehicle, for allowing said electric vehicle comprising said electrical receiving connector device to pull away from a breakable electrical connection between said electrical receiving connector device and said electrical supply connector device.

24. A method for attaching an electrical supply connector device and an electrical receiving connector device, comprising:
providing said electrical supply connector device comprising a flexible support member and a supply connector frame connected to a lower end of said flexible support member, wherein said supply connector frame comprises a plurality of magnetic nodes arranged in a first configuration;
providing said electrical receiving connector device comprising a receiving connector frame and a plurality of magnetic nodes arranged in said first configuration on said receiving connector frame;
aligning said receiving connector frame with said supply connector frame;
advancing said receiving connector frame towards said supply connector frame; and
attaching said magnetic nodes on said supply connector frame to a corresponding one of said magnetic nodes on said receiving connector frame, wherein said flexible support member comprising said supply connector frame located at said lower end of said flexible support member reduces a precision and a force required for establishing a connection between said electrical supply connector device and said electrical receiving connector device by providing flexibility for movement of said supply connector frame towards said receiving connector frame when said magnetic nodes on said supply connector frame and said plurality of magnetic nodes on said receiving connector frame of said electrical receiving connector device are in proximity with each other, and wherein said magnetic nodes on said supply connector frame are configured to magnetically attract and attach to said corresponding one of said magnetic nodes on said receiving connector frame.

25. The method of claim 24, further comprising:
initiating a flow of electrical current from said electrical power supply to said magnetic nodes of said electrical supply connector device by a supply relay circuit; and
establishing a circuit path for flow of said electrical current through a receiving relay circuit of said electrical receiving connector device for charging one or more batteries connected to said receiving relay circuit using said electrical current flowing through said magnetic nodes of said electrical receiving connector device attached to said magnetic nodes of said electrical supply connector device.

26. The method of claim 24, further comprising:
generating an electromagnetic field by a supply inductor coil located in said supply connector frame; and
transferring energy to a receiving inductor coil in said receiving connector frame, when said supply inductor coil is aligned with said receiving inductor coil.
